(19) United States
(12) Patent Application Publication
(10) Pub. No.: US 2025/0211438 A1
(43) Pub. Date: Jun. 26, 2025

(54) INFORMATION PROCESSING APPARATUS, INFORMATION PROCESSING METHOD, AND COMPUTER READABLE MEDIUM

(71) Applicant: NEC Corporation, Tokyo (JP)

(72) Inventor: Seiji ITO, Tokyo (JP)

(73) Assignee: NEC Corporation, Tokyo (JP)

(21) Appl. No.: 18/973,204

(22) Filed: Dec. 9, 2024

(30) Foreign Application Priority Data
Dec. 21, 2023 (JP) 2023-215540

(51) Int. Cl. H04L 9/30

(52) U.S. Cl. CPC H04L 9/30

(57) ABSTRACT

The present disclosure provides an information processing apparatus including: at least one memory storing instructions; and at least one processor configured to execute the instructions to: generate a first random number key, output the first random number key, and record the first random number key in the memory; encrypt, with the first random number key recorded in the memory, a second random number key used to encrypt first data to be uploaded, to thereby generate second data, record the second data in the memory, and erase the second random number key and the first random number key recorded in the memory; and decrypt the second random number key that decrypts the first data to be downloaded based on the acquired first random number key and the second data recorded in the memory.

### INCORPORATION BY REFERENCE

This application is based upon and claims the benefit of priority from Japanese patent application No. 2023-215540, filed on Dec. 21, 2023, the disclosure of which is incorporated herein in its entirety by reference.

### TECHNICAL FIELD

The present disclosure relates to an information processing apparatus, an information processing method, and a program.

### BACKGROUND ART

Patent Literature 1 discloses a technology in which a relay apparatus relays communication between a plurality of terminal apparatuses in a case where the plurality of terminal apparatuses communicate with each other, and the relay apparatus and the terminal apparatuses communicate data encrypted by a one-time pad.

Patent Literature 1: Japanese Unexamined Patent Application Publication No. 2014-078875

However, in the technology disclosed in Patent Literature 1, for example, a case where a user downloads data encrypted and uploaded at a first place and decrypts it at a second place has not been studied. In this case, for example, in a case where the user moves from the first place to the second place while holding an encryption key, a security problem occurs in the event of theft of the encryption key or the like.

### SUMMARY

In view of the above-described problem, an object of the present disclosure is to provide a technology by which it is possible to improve security even in a case where data encrypted and uploaded at a first place is downloaded and decrypted at a second place.

An information processing apparatus according to a first example aspect of the present disclosure is an information processing apparatus including: at least one memory storing instructions; and at least one processor configured to execute the instructions to: generate a first random number key, output the first random number key, and record the first random number key in the memory; encrypt, with the first random number key recorded in the memory, a second random number key used to encrypt first data to be uploaded, to thereby generate second data, record the second data in the memory, and erase the second random number key and the first random number key recorded in the memory; and decrypt the second random number key that decrypts the first data to be downloaded based on the acquired first random number key and the second data recorded in the memory.

Further, an information processing method according to a second example aspect of the present disclosure is an information processing method performed by an information processing apparatus including a memory, the information processing method including: generating a first random number key, outputting the first random number key, and recording the first random number key in the memory; encrypting, with the first random number key recorded in the memory, a second random number key used to encrypt first data to be uploaded, to thereby generate second data, recording the second data in the memory, and erasing the second random number key and the first random number key recorded in the memory; and decrypting the second random number key that decrypts the first data to be downloaded based on the acquired first random number key and the second data recorded in the memory.

Further, a non-transitory computer readable medium according to a third example aspect of the present disclosure is a non-transitory computer readable medium storing a program for causing a computer including a memory to: generate a first random number key, output the first random number key, and record the first random number key in the memory; encrypt, with the first random number key recorded in the memory, a second random number key used to encrypt first data to be uploaded, to thereby generate second data, record the second data in the memory, and erase the second random number key and the first random number key recorded in the memory; and decrypt the second random number key that decrypts the first data to be downloaded based on the acquired first random number key and the second data recorded in the memory.

According to one example aspect of the present disclosure, it is possible to improve security even in a case where data encrypted and uploaded at a first place is downloaded and decrypted at a second place.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a diagram showing an example of a configuration of an information processing apparatus according to an example embodiment;

FIG. 2 is a diagram showing an example of a configuration of an information processing system according to an example embodiment;

FIG. 3 is a diagram showing an example of a hardware configuration of the information processing apparatus according to an example embodiment; and

FIG. 4 is a flowchart showing an example of processes performed by the information processing apparatus according to an example embodiment.

### EXAMPLE EMBODIMENT

The principle of the present disclosure will be described with reference to some illustrative example embodiments. It should be understood that these example embodiments are described for illustrative purposes only and will assist those skilled in the art in understanding and implementing the present disclosure without suggesting any limitations with regard to the scope of the present disclosure. The disclosure described herein may be implemented in a variety of ways other than those described below.

In the following description and claims, unless otherwise defined, the meanings of all technical and scientific terms used herein are the same as those generally understood by those skilled in the art to which the present disclosure pertains.

Example embodiments of the present disclosure will be described hereinafter with reference to the drawings. Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

### First Example Embodiment

### Configuration

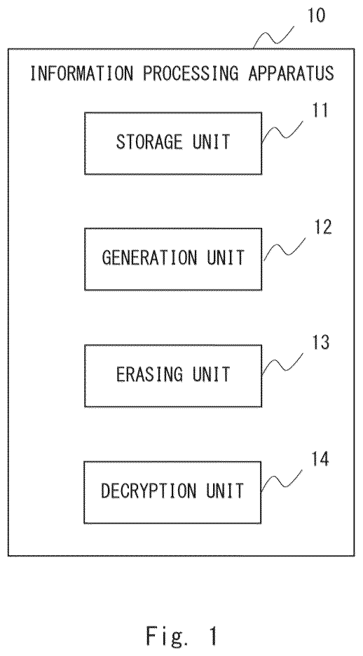

A configuration of an information processing apparatus 10 according to an example embodiment will be described with reference to FIG. 1. FIG. 1 is a diagram showing an example of a configuration of the information processing apparatus 10 according to the example embodiment. The information processing apparatus 10 includes a storage unit (memory) 11, a generation unit 12, an erasing unit 13, and a decryption unit 14. These units may be implemented by one or more programs installed in the information processing apparatus 10 and hardware of the information processing apparatus 10 such as a processor 101 and a memory 102 operating in cooperation with each other.

The storage unit 11 records various types of data. The generation unit 12 generates a first random number key. Further, the generation unit 12 outputs the first random number key to an external apparatus or the like. Further, the generation unit 12 records the first random number key in the storage unit 11.

The erasing unit 13 encrypts a second random number key used to encrypt first data to be uploaded with the first random number key recorded in the storage unit 11, thereby generating second data. The erasing unit 13 then records the second data in the storage unit 11, and erases the second random number key and the first random number key recorded in the storage unit 11. The decryption unit 14 decrypts the second random number key that decrypts the first data to be downloaded based on the first random number key acquired from an external apparatus or the like and the second data recorded in the storage unit 11.

### Second Example Embodiment

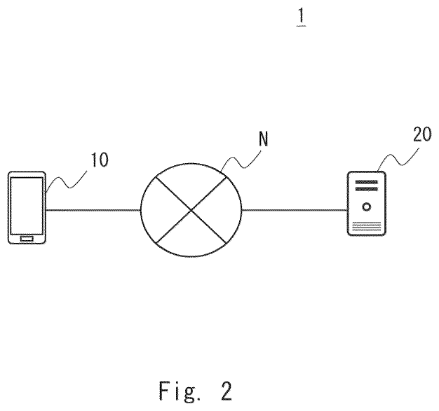

Next, a configuration of an information processing system 1 according to an example embodiment will be described with reference to FIG. 2.

### System Configuration

FIG. 2 is a diagram showing an example of the configuration of the information processing system 1 according to the example embodiment. In the example of FIG. 2, the information processing system 1 includes the information processing apparatus 10 and a server 20. In the example of FIG. 2, the information processing apparatus 10 is connected to the server 20 so that they can communicate with each other through a network N. Note that the number of the information processing apparatuses 10 and the number of the servers 20 are not limited to those shown in the example of FIG. 2.

Examples of the network N include, for example, the Internet, a mobile communication system, a wireless Local Area Network (LAN), a LAN, a bus, and the like. Examples of the mobile communication system include, for example, a fifth-generation mobile communication system (5G), a sixth-generation mobile communication system (6G, Beyond 5G), a fourth-generation mobile communication system (4G), a third-generation mobile communication system (3G), and the like.

The information processing apparatus 10 is, for example, a terminal such as a smartphone, a tablet, or a notebook-sized personal computer owned by a user. The server 20 is, for example, an apparatus such as a server, a cloud server, or a personal computer. The server 20 stores data uploaded from a terminal such as the information processing apparatus 10, and downloads the stored data to the terminal.

### Hardware Configuration

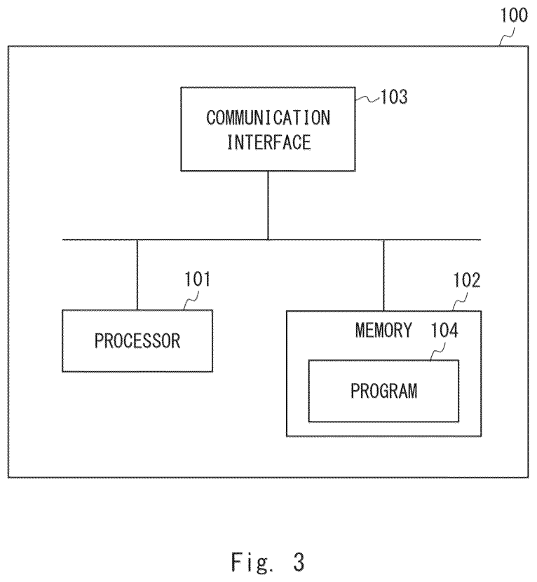

FIG. 3 is a diagram showing an example of a hardware configuration of the information processing apparatus 10 according to the example embodiment. In the example of FIG. 3, the information processing apparatus 10 (a computer 100) includes the processor 101, the memory 102, and a communication interface 103. These components may be connected by a bus or the like. The memory 102 stores at least a part of a program 104. The communication interface 103 includes an interface required for communication with other network elements.

When the program 104 is executed in cooperation with the processor 101, the memory 102, and the like, the computer 100 performs at least some of the processes of the example embodiments of the present disclosure. The memory 102 may be of any type suitable for a local technical network. The memory 102 may, as a non-limiting example, be a non-transitory computer readable storage medium. Further, the memory 102 may be implemented using any suitable data storage technology, such as a semiconductor-based memory device, a magnetic memory device and system, an optical memory device and system, a fixed memory, and a removable memory. Although only one memory 102 is shown in the computer 100, the computer 100 may include several memory modules that are physically different from each other. The processor 101 may be of any type. The processor 101 may include one or more of a general-purpose computer, a dedicated computer, a microprocessor, a Digital Signal Processor (DSP), and a processor based on a multi-core processor architecture as a non-limiting example.

The computer 100 may include a plurality of processors, such as an application-specific integrated circuit chip that is temporally dependent on a clock that synchronizes the main processor.

The example embodiments of the present disclosure may be implemented in hardware or a dedicated circuit, software, logic, or any combination thereof. Some example aspects may be implemented in hardware, while other example aspects may be implemented in firmware or software that may be executed by a controller, a microprocessor, or other computing devices.

The present disclosure also provides at least one computer program product that is tangibly stored in a non-transitory computer readable storage medium. The computer program product includes computer executable instructions, such as instructions included in program modules, and is executed on a device on a target real or virtual processor to perform the processes or the method according to the present disclosure. The program modules include routines, programs, libraries, objects, classes, components, data structures, and the like that perform specific tasks or implement specific abstract data types. The functions of the program modules may be combined or divided among the program modules as desired in various example embodiments. Machine executable instructions for the program modules can be executed in a local or a distributed device. In a distributed device, program modules can be located in both local and remote storage media.

Program codes for performing the method according to the present disclosure may be written in any combination of one or more programming languages. These program codes are provided to a processor or a controller of a general-purpose computer, a dedicated computer, or other programmable data processing apparatuses. When the program codes are executed by the processor or the controller, functions/operations in the flowchart and/or a block diagram to be implemented are executed. The program codes are executed entirely on a machine, partly on a machine, as a stand-alone software package, partly on a machine, partly on a remote machine, or entirely on a remote machine or a server.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

### Processing

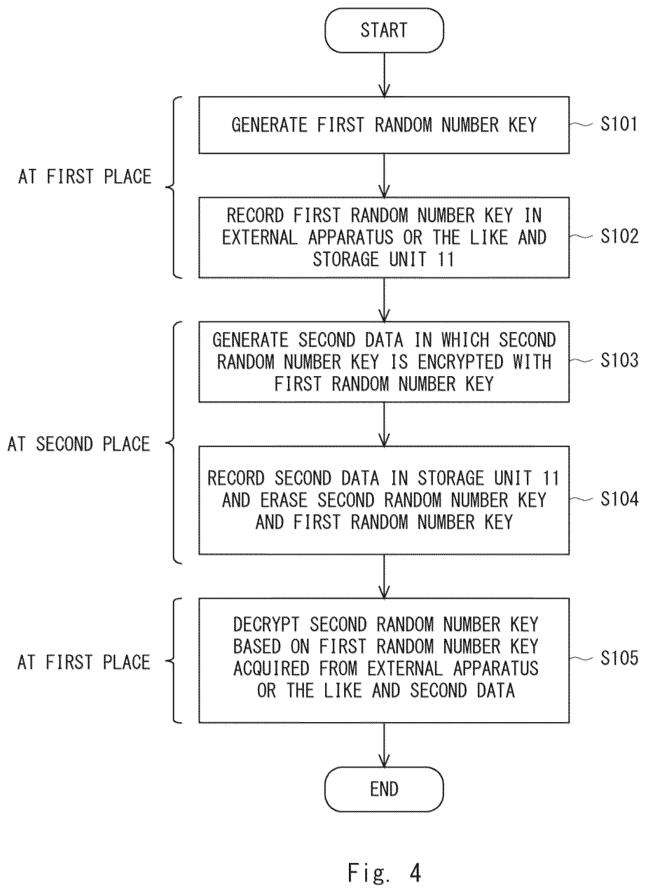

Next, an example of processes performed by the information processing apparatus 10 according to the example embodiment will be described with reference to FIG. 4. FIG. 4 is a flowchart showing the example of processes performed by the information processing apparatus 10 according to the example embodiment.

Note that the following processes of Steps S101 and S102 may be executed at a place (a first place) where data downloaded from the server 20 is decrypted, such as a user's home or workplace. In Step S101, the generation unit 12 generates a first random number key. Note that, for example, the generation unit 12 may generate a random number of a specific data size (e.g., one gigabyte) as the first random number key.

Next, the generation unit 12 outputs the first random number key to an external apparatus or the like and records the same in the external apparatus or the like, and further records the first random number key in the storage unit 11 (Step S102). Note that either the process for outputting the first random number key to an external apparatus or the like or the process for recording the first random number key in the storage unit 11 may be executed first.

Here, the generation unit 12 may output the first random number key to a removable storage medium (an external apparatus) or the like, such as a Universal Serial Bus (USB) memory or an SD memory card, and record the same in the removable storage medium or the like. Note that the storage medium may be kept, for example, in a locked and secure place at the first place such as a home.

Further, the generation unit 12 also records the first random number key in the storage unit 11 of the information processing apparatus 10. Note that the storage unit 11 may be a Solid State Drive (SSD) or the like incorporated in the information processing apparatus 10. The storage unit 11 may include a plurality of storage apparatuses.

Note that the following processes of Steps S103 and S104 may be executed at a place (a second place) where data is uploaded to the server 20, such as a business trip destination or a customer site of a user. Note that a user may encrypt confidential data with the second random number key and upload it to the server 20, for example, by using the information processing apparatus 10 or a terminal (e.g., a personal computer) different from the information processing apparatus 10 present at the second place.

Next, the erasing unit 13 generates second data in which the second random number key used to encrypt first data to be uploaded is encrypted with the first random number key recorded in the storage unit 11 (Step S103). Here, the erasing unit 13 may, for example, encrypt the second random number key with the first random number key using a one-time pad. Note that the one-time pad may be an encryption method using a random number sequence no more than once. In this case, the erasing unit 13 may, for example, generate second data in which the second random number key is encrypted using an eXclusive OR (XOR) of the second random number key and a random number sequence of the first random number key having the same length (the data size) as that of the second random number key.

Further, the erasing unit 13 may, for example, determine whether or not the data size of the first random number key is equal to or larger than the data size of the second random number key. In a case where the data size of the first random number key is equal to or larger than the data size of the second random number key, the erasing unit 13 may encrypt the second random number key with the first random number key using a one-time pad.

On the other hand, in a case where the data size of the first random number key is not larger than the data size of the second random number key, the erasing unit 13 may encrypt the second random number key with the first random number key using an encryption method other than a one-time pad. In this case, for example, the erasing unit 13 may perform encryption using at least some of the random number sequences included in the first random number key a plurality of times. In this case, for example, the erasing unit 13 may generate the second data in which the second random number key is encrypted using an exclusive OR of the second random number key and a random number sequence having the same length as that of the second random number key generated based on the first random number key. The erasing unit 13 may encrypt the second random number key with the first random number key, for example, by using Advanced Encryption Standard (AES).

Next, the erasing unit 13 records the second data in the storage unit 11, and erases the second random number key and the unencrypted first random number key recorded in the storage unit 11 (Step S104). By doing so, even if the information processing apparatus 10, for example, is stolen while a user is returning from the second place to the first place, passing of a combination of the first random number key and the second data with which the second random number key can be restored, and the second random number key itself to a malicious person can be prevented. Therefore, for example, even in a case where security is breached by the password and the like of the information processing apparatus 10 and the password and the like for login to the server 20 being used, it is possible to reduce the number of occurrences of the decryption of confidential data.

Note that the process for recording the second data in the storage unit 11, the process for erasing the second random number key, and the process for erasing the first random number key recorded in the storage unit 11 may be executed in any order.

Note that the following process of Step S105 may be executed at a place (the first place) where data downloaded from the server 20 is decrypted, such as a user's home or workplace. Next, the decryption unit 14 decrypts the second random number key that decrypts the first data to be downloaded based on the first random number key acquired from an external apparatus or the like and the second data recorded in the storage unit 11 (Step S105). By doing so, a user can decrypt the encryption of confidential data downloaded from the server 20 with the second random number key.

The decryption unit 14 may determine whether or not information indicating the position at which the second random number key is decrypted in Step S105 satisfies a predetermined condition based on information indicating the position at which the first random number key is generated by the generation unit 12 in Step S101. Then, in a case where the predetermined condition is satisfied, the decryption unit 14 may decrypt the second random number key. On the other hand, in a case where the predetermined condition is not satisfied, the decryption unit 14 may reject the decryption of the second random number key and provide a user with error information indicating that the decryption has been rejected. By doing so, for example, it is possible to reduce the number of occurrences of the decryption of the second random number key at a place other than the first place such as a user's home.

In this case, the generation unit 12 may acquire information indicating a position (a first position) of the information processing apparatus 10 in a case where the first random number key is generated, and record the information indicating the position in the storage unit 11. Then, in a case where the decryption unit 14 decrypts the second random number key, it may acquire information indicating a position (a second position) of the information processing apparatus 10, and determine whether or not the predetermined condition is satisfied.

Note that, in the present disclosure, information indicating the position of the information processing apparatus 10 may be measured, for example, using a satellite positioning system such as a Global Positioning System (GPS). Further, in the present disclosure, information indicating the position of the information processing apparatus 10 may be acquired, for example, from a base station (an access point) of a wireless Local Area Network (LAN). Further, information indicating the position of the information processing apparatus 10 may be acquired, for example, from a base station (e.g., next generation Node B (gNB)) of a mobile phone carrier.

In the present disclosure, information indicating the position of the information processing apparatus 10 may be, for example, information indicating latitude and longitude. In this case, the predetermined condition may include, for example, that a distance between the first position and the second position is equal to or less than a threshold.

Further, in the present disclosure, information indicating the position of the information processing apparatus 10 may be, for example, identification information (e.g., a Service Set Identifier (SSID) of a wireless LAN or a cell ID of a mobile communication system) corresponding to a base station to which the information processing apparatus 10 is connected (a base station within which the information processing apparatus 10 is located). In this case, the predetermined condition may include, for example, that identification information corresponding to the base station to which the information processing apparatus 10 is connected at the first position and identification information corresponding to the base station to which the information processing apparatus 10 is connected at the second position are identical.

(Example of a case in which the first random number key is encrypted and stored in the information processing apparatus 10)

In the example described above, in Step S102, the first random number key is recorded in an external apparatus kept in a home or the like, and in Step S105, the first random number key is acquired from the external apparatus. Alternatively, or in addition to doing the above, the generation unit 12 or the erasing unit 13 may encrypt the first random number key and record it in the storage unit 11, and the decryption unit 14 may decrypt the first random number key only at the first place and acquire it. Thus, for example, an external apparatus is not required. In this case, the decryption unit 14 may decrypt the first random number key from third data in which the first random number key is encrypted in a case where information indicating the position at which the second random number key is decrypted satisfies a predetermined condition based on information indicating the position at which the first random number key is generated by the generation unit 12.

In this case, the generation unit 12 may acquire the information indicating the first position described above and record it in the storage unit 11. Then the decryption unit 14 may acquire the information indicating the second position described above and determine whether or not the predetermined condition described above is satisfied. The process for encrypting the first random number key and recording it in the storage unit 11 may be executed by the generation unit 12 in Step S102, or may be executed by the erasing unit 13 in Step S104.

### Modified Example

The information processing apparatus 10 may be an apparatus included in one housing, but the information processing apparatus 10 according to the present disclosure is not limited thereto. Each unit of the information processing apparatus 10 may be implemented by, for example, cloud computing composed of one or more computers. The information processing apparatus 10 described above is also included in an example of the “information processing apparatus” according to the present disclosure.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims.

Note that the present disclosure is not limited to the above-described example embodiments and may be changed as appropriate without departing from the scope and spirit of the present disclosure.

The whole or part of the example embodiments disclosed above can be described as, but not limited to, the following supplementary notes. Note that some or all of elements (e.g., structures and functions) specified in supplementary notes dependent on supplementary note 1 may also be dependent on independent supplementary notes of other categories in dependency similar to that of supplementary notes on supplementary note 1. Some or all of elements specified in any of supplementary notes may be applied to various types of hardware, software, and recording means for recording software, systems, and methods.

### Supplementary Note 1

An information processing apparatus comprising:
at least one memory storing instructions; and
at least one processor configured to execute the instructions to:
   generate a first random number key, output the first random number key, and record the first random number key in the memory;
   encrypt, with the first random number key recorded in the memory, a second random number key used to encrypt first data to be uploaded, to thereby generate second data, record the second data in the memory, and erase the second random number key and the first random number key recorded in the memory; and
   decrypt the second random number key that decrypts the first data to be downloaded based on the acquired first random number key and the second data recorded in the memory.

### Supplementary Note 2

The information processing apparatus according to supplementary note 1, wherein the at least one processor is configured to execute the instructions to:
generate the first random number key, output the first random number key to an external apparatus, and record the first random number key in the memory; and
decrypt the second random number key based on the first random number key acquired from the external apparatus and the second data.

### Supplementary Note 3

The information processing apparatus according to supplementary note 2, wherein
the external apparatus is located at a first place where the first random number key is generated, and
the first place is different from a second place where the second data is generated.

### Supplementary Note 4

The information processing apparatus according to supplementary note 1 or 2, wherein the information processing apparatus generates the first random number key at the first place, generates the second data at the second place, and decrypts the second random number key at the first place.

### Supplementary Note 5

The information processing apparatus according to supplementary note 1 or 2, wherein the at least one processor is configured to execute the instructions to encrypt the second random number key with the first random number key using a one-time pad.

### Supplementary Note 6

The information processing apparatus according to supplementary note 1 or 2, wherein the at least one processor is configured to execute the instructions to:
in a case where a data size of the first random number key is equal to or larger than a data size of the second random number key, encrypt the second random number key with the first random number key using a one-time pad; and
in a case where a data size of the first random number key is not equal to or larger than a data size of the second random number key, encrypt the second random number key with the first random number key using an encryption method other than a one-time pad.

### Supplementary Note 7

The information processing apparatus according to supplementary note 1 or 2, wherein the at least one processor is configured to execute the instructions to, in a case where information indicating a position at which the second random number key is decrypted satisfies a predetermined condition based on information indicating a position at which the first random number key is generated, decrypt the second random number key.

### Supplementary Note 8

The information processing apparatus according to supplementary note 1 or 2, wherein the at least one processor is configured to execute the instructions to, in a case where information indicating a position at which the second random number key is decrypted satisfies a predetermined condition based on information indicating a position at which the first random number key is generated, decrypt the first random number key from third data in which the first random number key is encrypted.

### Supplementary Note 9

An information processing method performed by an information processing apparatus comprising a memory, the information processing method comprising:
generating a first random number key, outputting the first random number key, and recording the first random number key in the memory;
encrypting, with the first random number key recorded in the memory, a second random number key used to encrypt first data to be uploaded, to thereby generate second data, recording the second data in the memory, and erasing the second random number key and the first random number key recorded in the memory; and
decrypting the second random number key that decrypts the first data to be downloaded based on the acquired first random number key and the second data recorded in the memory.

### Supplementary Note 10

A non-transitory computer readable medium storing a program for causing a computer comprising a memory to:
generate a first random number key, output the first random number key, and record the first random number key in the memory;
encrypt, with the first random number key recorded in the memory, a second random number key used to encrypt first data to be uploaded, to thereby generate second data, record the second data in the memory, and erase the second random number key and the first random number key recorded in the memory; and
decrypt the second random number key that decrypts the first data to be downloaded based on the acquired first random number key and the second data recorded in the memory.

### Supplementary Note 11

An information processing system comprising an information processing apparatus and a server,
wherein the information processing apparatus comprises:
at least one memory storing instructions; and
at least one processor configured to execute the instructions to:
   generate a first random number key, output the first random number key, and record the first random number key in the memory;
   encrypt, with the first random number key recorded in the memory, a second random number key used to encrypt first data to be uploaded to the server, to thereby generate second data, record the second data in the memory, and erase the second random number key and the first random number key recorded in the memory; and
   decrypt the second random number key that decrypts the first data to be downloaded from the server based on the acquired first random number key and the second data recorded in the memory.

What is claimed is:

1. An information processing apparatus comprising:
at least one memory storing instructions; and
at least one processor configured to execute the instructions to:
generate a first random number key, output the first random number key, and record the first random number key in the memory;
encrypt, with the first random number key recorded in the memory,
a second random number key used to encrypt first data to be uploaded, to thereby generate second data, record the second data in the memory, and erase the second random number key and the first random number key recorded in the memory; and
decrypt the second random number key that decrypts the first data to be downloaded based on the acquired first random number key and the second data recorded in the memory.

2. The information processing apparatus according to claim 1, wherein the at least one processor is configured to execute the instructions to:
generate the first random number key, output the first random number key to an external apparatus, and record the first random number key in the memory; and
decrypt the second random number key based on the first random number key acquired from the external apparatus and the second data.

3. The information processing apparatus according to claim 2, wherein
the external apparatus is located at a first place where the first random number key is generated, and
the first place is different from a second place where the second data is generated.

4. The information processing apparatus according to claim 1, wherein the information processing apparatus generates the first random number key at the first place, generates the second data at the second place, and decrypts the second random number key at the first place.

5. The information processing apparatus according to claim 1, wherein the at least one processor is configured to execute the instructions to encrypt the second random number key with the first random number key using a one-time pad.

6. The information processing apparatus according to claim 1, wherein the at least one processor is configured to execute the instructions to:
in a case where a data size of the first random number key is equal to or larger than a data size of the second random number key, encrypt the second random number key with the first random number key using a one-time pad; and
in a case where a data size of the first random number key is not equal to or larger than a data size of the second random number key, encrypt the second random number key with the first random number key using an encryption method other than a one-time pad.

7. The information processing apparatus according to claim 1, wherein the at least one processor is configured to execute the instructions to, in a case where information indicating a position at which the second random number key is decrypted satisfies a predetermined condition based on information indicating a position at which the first random number key is generated, decrypt the second random number key.

8. The information processing apparatus according to claim 1, wherein the at least one processor is configured to execute the instructions to, in a case where information indicating a position at which the second random number key is decrypted satisfies a predetermined condition based on information indicating a position at which the first random number key is generated, decrypt the first random number key from third data in which the first random number key is encrypted.

9. An information processing method performed by an information processing apparatus comprising a memory, the information processing method comprising:
generating a first random number key, outputting the first random number key, and recording the first random number key in the memory;
encrypting, with the first random number key recorded in the memory, a second random number key used to encrypt first data to be uploaded, to thereby generate second data, recording the second data in the memory, and erasing the second random number key and the first random number key recorded in the memory; and
decrypting the second random number key that decrypts the first data to be downloaded based on the acquired first random number key and the second data recorded in the memory.

10. A non-transitory computer readable medium storing a program for causing a computer comprising a memory to:
generate a first random number key, output the first random number key, and record the first random number key in the memory;
encrypt, with the first random number key recorded in the memory, a second random number key used to encrypt first data to be uploaded, to thereby generate second data, record the second data in the memory, and erase the second random number key and the first random number key recorded in the memory; and
decrypt the second random number key that decrypts the first data to be downloaded based on the acquired first random number key and the second data recorded in the memory.
